(19) United States
(12) Patent Application Publication
(10) Pub. No.: US 2013/0021210 A1
(43) Pub. Date: Jan. 24, 2013

(54) WIRELESS COMMUNICATION APPARATUS

(71) Applicant: Kouji SOEKAWA, Kawasaki (JP)

(72) Inventor: Kouji SOEKAWA, Kawasaki (JP)

(73) Assignee: FUJITSU LIMITED, Kawasaki-shi (JP)

(21) Appl. No.: 13/480,366

(22) Filed: May 24, 2012

(30) Foreign Application Priority Data
Jul. 22, 2011 (JP) 2011-161393

(51) Int. Cl. H01Q 9/04

(52) U.S. Cl. 343/700 MS

(57) ABSTRACT

A wireless communication apparatus performs a communication using high-frequency wave having a wavelength of λ. The apparatus includes a circuit board including a feeder point and a ground, an antenna element connected to the feeder point, and a wiring element including a first end portion and a second end portion different from the first end portion, the first end portion being connected to one of the feeder point and the antenna element, the second end portion being connected to the ground, wherein the antenna element has a length of λ/4, and the wiring element has a length of 3λ/4.

### CROSS-REFERENCE TO RELATED APPLICATION

This application is based upon and claims the benefit of priority of the prior Japanese Patent Application No. 2011-161393, filed on Jul. 22, 2011, the entire contents of which are incorporated herein by reference.

### FIELD

The embodiments discussed herein are related to a wireless communication apparatus included in, for example, a mobile phone in which a monopole antenna is mounted.

### BACKGROUND

In recent years, mobile phones having antennas mounted therein for the sake of design have become popular. Monopole antennas, for example, are used as the built-in antennas. In a monopole antenna mounted in a mobile phone, a ground pattern provided on a circuit board is used as the ground for the antenna. Therefore, the space occupied by the monopole antenna is smaller than the space occupied by, for example, a dipole antenna. This is advantageous in reducing the size of the mobile phone.

Japanese Laid-open Patent Publication No. 2006-196994 is an example of the related art.

To achieve good antenna characteristics with the monopole antenna, an antenna element is preferably located as far from the circuit board as possible to reduce the influence of various patterns and components on the circuit board. However, with the recent increase in functionality and reduction in size of mobile phones, it has become common to densely arrange the components and substrates in housings of the mobile phones. Accordingly, it has become difficult to place the antenna element far enough from the circuit board. Thus, the input impedance of the monopole antenna may vary, and the antenna characteristics may be deteriorated.

### SUMMARY

According to an aspect of the invention, a wireless communication apparatus performs a communication using high-frequency wave having a wavelength of λ. The apparatus includes a circuit board including a feeder point and a ground, an antenna element connected to the feeder point, and a wiring element including a first end portion and a second end portion different from the first end portion, the first end portion being connected to one of the feeder point and the antenna element, the second end portion being connected to the ground, wherein the antenna element has a length of λ/4, and the wiring element has a length of 3λ/4.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a mobile phone according to a first embodiment;

FIG. 2 is a plan view of an electronic unit according to the first embodiment;

FIG. 3 is a perspective view of a connecting section between the electronic unit and an antenna unit according to the first embodiment;

FIGS. 4A and 4B are perspective views of the antenna unit according to the first embodiment;

FIG. 5 is a schematic diagram illustrating a current distribution in a bypass element included in the antenna unit according to the first embodiment;

FIG. 6 illustrates the result of simulation of the current distribution in the antenna unit according to the first embodiment;

FIGS. 7A and 7B are schematic diagrams which each illustrate a current distribution in a ground pattern on a circuit board according to the first embodiment;

FIG. 8 is a graph of the VSWR of a comparative antenna unit that does not include the bypass element according to the first embodiment;

FIG. 9 is a graph of the VSWR of the antenna unit including the bypass element according to the first embodiment;

FIG. 10 is a perspective view of a connecting section between an electronic unit and an antenna unit according to a second embodiment;

FIG. 11 is a schematic diagram illustrating a current distribution in a ground pattern on a circuit board according to the second embodiment;

FIG. 12 is a perspective view of a connecting section between an electronic unit and an antenna unit according to a third embodiment;

FIGS. 13A and 13B are perspective views of the antenna unit according to the third embodiment; and

FIG. 14 is a graph of the VSWR of the antenna unit including a bypass element according to the third embodiment.

### DESCRIPTION OF EMBODIMENTS

### First Embodiment

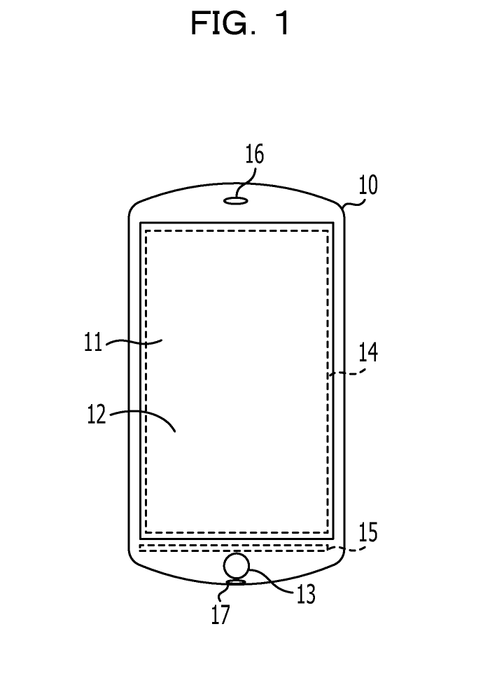

A first embodiment will now be described with reference to FIGS. 1 to 9.

### Mobile Phone

FIG. 1 is a schematic diagram illustrating a mobile phone according to the first embodiment.

As illustrated in FIG. 1, the mobile phone according to the first embodiment includes a housing 10 that is held by a user; a display 11 that is mounted on the housing 10 and displays various information; a touch panel 12 that is mounted on the front surface of the display 11 and through which information is input to the mobile phone; an operation button 13 disposed on the housing 10 at a position near a mouthpiece 17; an electronic unit 14 that is disposed in the housing 10 and performs various functions of the mobile phone; an antenna unit 15 that is disposed in the housing 10 and establishes a wireless connection with a mobile phone network; an earpiece 16 disposed at the upper section of the display 11; and the mouthpiece 17 disposed at the lower section of the display 11.

### Electronic Unit 14

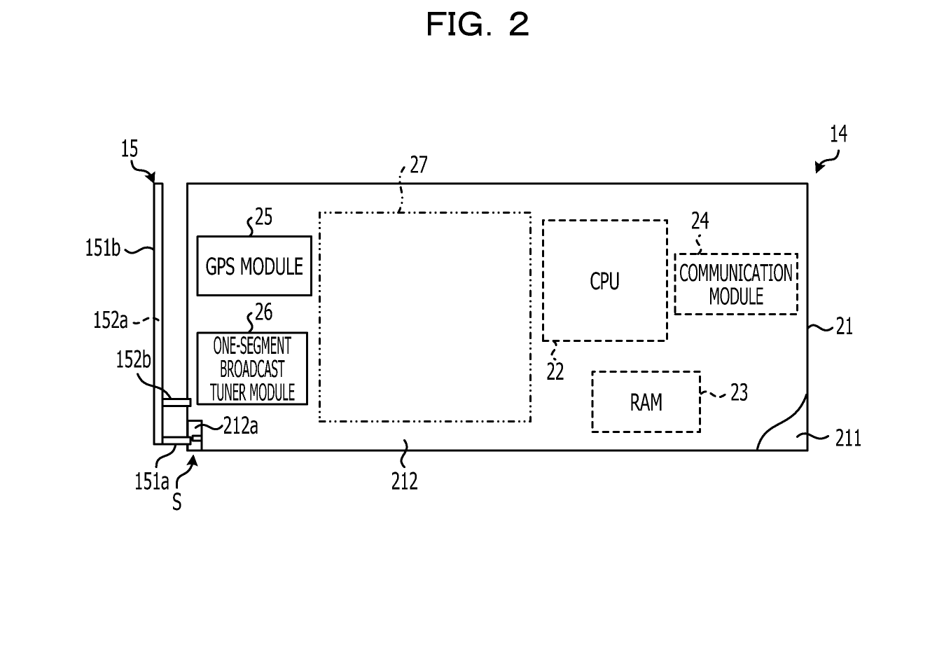

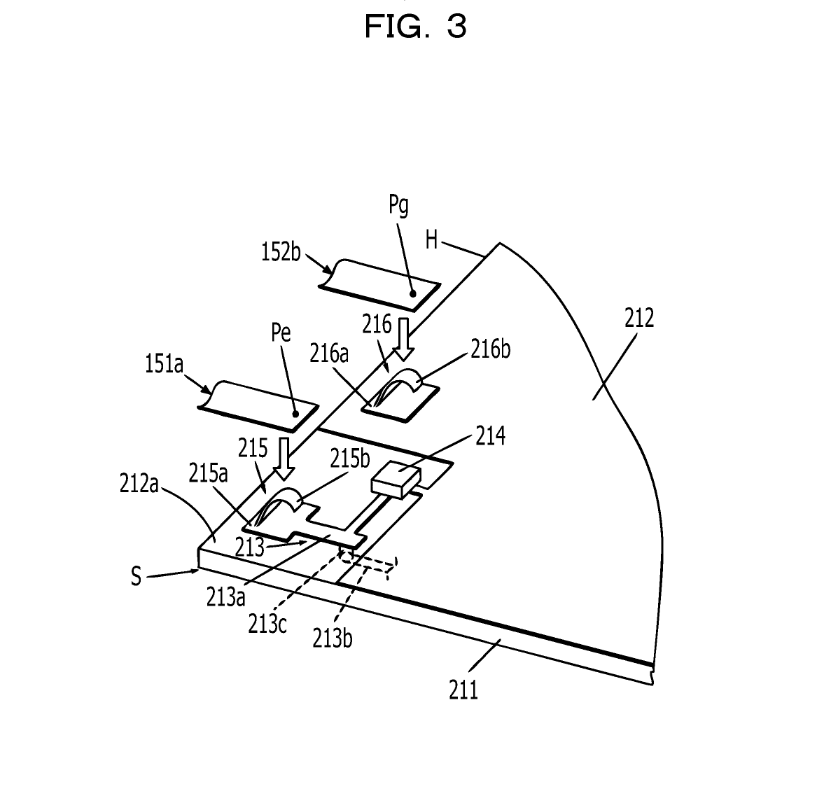

FIG. 2 is a plan view of the electronic unit 14 according to the first embodiment. FIG. 3 is a perspective view of a connecting section between the electronic unit 14 and the antenna unit 15 according to the first embodiment.

As illustrated in FIGS. 2 and 3, the electronic unit 14 includes a substantially rectangular plate-shaped circuit board 21 and components mounted on the circuit board 21. The components mounted on the circuit board 21 include electronic components, such as a central processing unit (CPU) 22, a random access memory (RAM) 23, and a communication module 24, other components 25 and 26, and a battery 27 that serves as the power source for the mobile phone.

The type of the circuit board 21 is not particularly limited. In the present embodiment, a double-sided printed wiring board is used. Each of the electronic components and other components is mounted on the front side or the back side of the circuit board 21.

The circuit board 21 includes a core substrate 211, a ground pattern 212 formed on the front side of the core substrate 211, and a wiring pattern (not illustrated) formed on the back side of the core substrate 211. The ground pattern 212 is basically formed over the entire area of the front side of the core substrate 211, but has a vacant area 212a at a lower right corner S of the mobile phone. The front side of the core substrate 211 is exposed at the vacant area 212a.

The circuit board 21 further includes a feeder 213 for supplying high-frequency power received from the communication module 24 to the antenna unit 15; a matching circuit 214 for achieving an impedance match between the feeder 213 and the antenna unit 15; and a feeder contact 215 and a ground contact 216 for connecting the antenna unit 15 to the circuit board 21.

The feeder 213 includes an exposed pattern 213a that is exposed at the vacant area 212a in the ground pattern 212; an inner pattern 213b that is embedded in the core substrate 211 and connected to the communication module 24; and a via 213c that connects the exposed pattern 213a to the inner pattern 213b. The characteristic impedance of the feeder 213 is not particularly limited, and is about 50Ω in the present embodiment.

In the present embodiment, a conductive pattern formed on the front side of the core substrate 211 is used as the feeder 213. However, the embodiment is not limited to this, and a coaxial cable, for example, may be used instead.

The matching circuit 214 is connected between the feeder 213 and the ground pattern 212. The output impedance of the matching circuit 214 is equivalent to the characteristic impedance of the feeder 213, and is about 50Ω in the present embodiment. The type of the matching circuit 214 is not particularly limited. In the present embodiment, a packaged component is used.

The feeder contact 215 and the ground contact 216 are arranged near the bottom edge H of the circuit board 21, that is, near the antenna unit 15, with an interval therebetween, the interval being equivalent to an interval between a first antenna portion 151a of an antenna element 151 and a second bypass portion 152b of a bypass element 152.

The feeder contact 215 is disposed in the vacant area 212a in the ground pattern 212, and includes a base portion 215a that is connected to the feeder 213 and a spring portion 215b that is connected to the base portion 215a. The ground contact 216 includes a base portion 216a that is connected to the ground pattern 212 and a spring portion 216b that is connected to the base portion 216a.

The material of the feeder contact 215 and the ground contact 216 is not particularly limited. In the present embodiment, a metal material, such as Cu, is used. Accordingly, the spring portion 215b of the feeder contact 215 has the same potential as that of the feeder 213, and the spring portion 216b of the ground contact 216 has the same potential as that of the ground pattern 212.

### Antenna Unit 15

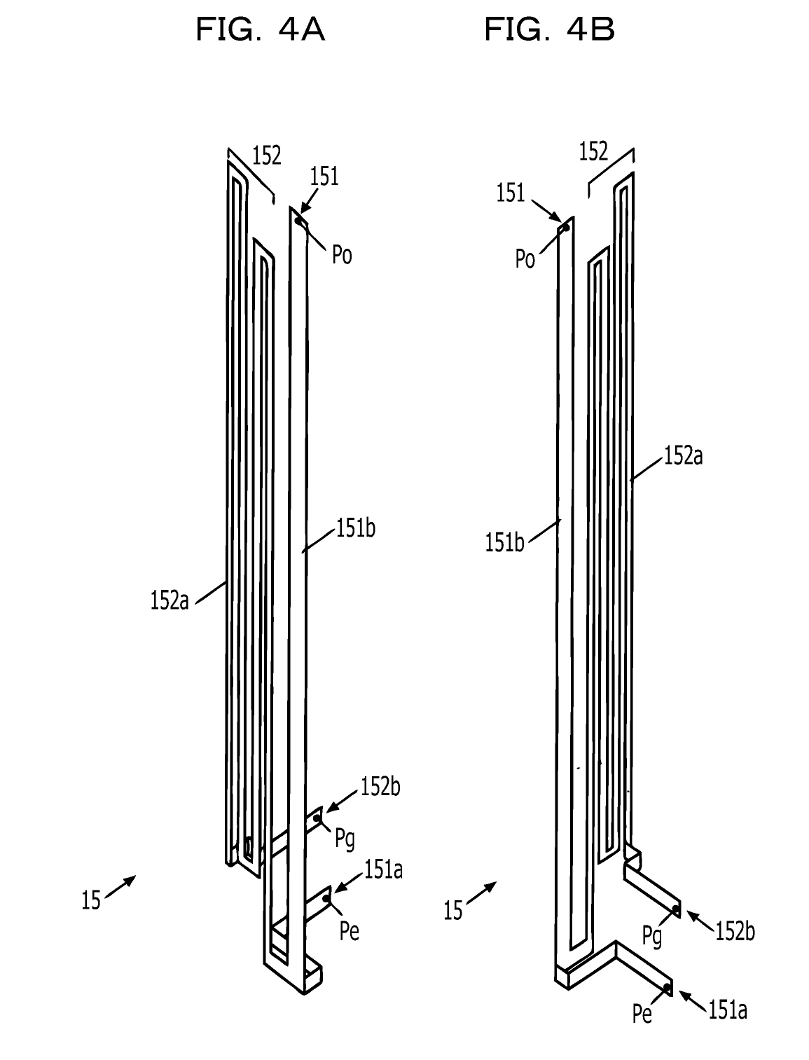

FIGS. 4A and 4B are perspective views of the antenna unit 15 according to the first embodiment.

As illustrated in FIGS. 4A and 4B, the antenna unit 15 according to the present embodiment includes the antenna element 151 and the bypass element 152.

The antenna element 151 is an inverted L-shaped monopole antenna, and includes the first antenna portion 151a that extends perpendicular to the bottom edge H of the circuit board 21 and a second antenna portion 151b that extends parallel to the bottom edge H of the circuit board 21. The first and second antenna portions 151a and 151b are connected to each other so as to form a substantially L shape.

The first antenna portion 151a basically has a thin band-plate-like shape, and is connected to the feeder contact 215 that is fixed to the circuit board 21. The point on the first antenna portion 151a at which the first antenna portion 151a is in contact with the feeder contact 215 is hereinafter referred to as a feeder point Pe.

The second antenna portion 151b basically has a thin band-plate-like shape, and an end of the second antenna portion 151b that is opposite to the end adjacent to the first antenna portion 151a is not restrained. The end of the second antenna portion 151b that is opposite to the end adjacent to the first antenna portion 151a is hereinafter referred to as a free end Po.

In the present embodiment, the length of the antenna element 151, that is, the distance between the feeder point Pe and the free end Po is set to about λ/4, where λ is the wavelength of the high-frequency power supplied from the communication module 24. When, for example, the bandwidth for the mobile phone is 840 MHz to 880 MHz, the wavelength λ of the high-frequency power is about 34.1 cm to 35.7 cm. Accordingly, the length of the antenna element 151, λ/4, is about 8.5 cm to 8.9 cm.

The bypass element 152 is coupled to the first antenna portion 151a of the antenna element 151 so as to form an auxiliary antenna for reducing the input impedance of the antenna unit 15. The bypass element 152 includes a first bypass portion 152a that extends parallel to the bottom edge H of the circuit board 21 and the second bypass portion 152b that extends perpendicular to the bottom edge H of the circuit board 21.

The first bypass portion 152a extends back and forth along the width of the mobile phone, and is connected to the antenna element 151 at a position near the feeder point Pe. In the present embodiment, the first bypass portion 152a is connected to the antenna element 151 at a position where the first and second antenna portions 151a and 151b branch from each other. The first bypass portion 152a extends back and forth twice along the width of the mobile phone. However, the embodiment is not limited to this.

The second bypass portion 152b is connected to the first bypass portion 152a at an end opposite to the end adjacent to the antenna element 151, and is also connected to the ground contact 216 that is fixed to the circuit board 21. The point on the second bypass portion 152b at which the second bypass portion 152b is in contact with the ground contact 216 is hereinafter referred to as a ground point Pg.

The sum of the length of the bypass element 152 and the length of the first antenna portion 151a of the antenna element 151, that is, the distance between the feeder point Pe and the ground point Pg, is set to about 3λ/4. When, for example, the bandwidth for the mobile phone is 840 MHz to 880 MHz, the wavelength λ of the high-frequency power is about 34.1 cm to 35.7 cm. Accordingly, the distance between the feeder point Pe and the ground point Pg is about 25.5 cm to 26.7 cm.

As described above, in the present embodiment, the bypass element 152 is coupled to the first antenna portion 151a of the antenna element 151 so as to form an auxiliary antenna for reducing the input impedance of the antenna unit 15. Accordingly, the sum of the length of the bypass element 152 and the length of the first antenna portion 151a of the antenna element 151 corresponds to the length of the auxiliary antenna. Therefore, the length of the auxiliary antenna is about 25.5 cm to 26.7 cm.

In the present embodiment, the first bypass portion 152a is connected to the antenna element 151 at the position where the first and second antenna portions 151a and 151b branch from each other. However, the embodiment is not limited to this. For example, the first bypass portion 152a may instead be connected to the antenna element 151 at the feeder point Pe. In the case where the first bypass portion 152a is connected to the antenna element 151 at the feeder point Pe, the length of the bypass element 152 corresponds to the distance from the feeder point Pe to the ground point Pg, and to the length of the auxiliary antenna.

The width of the antenna element 151 is not particularly limited, and is about 1 mm in the present embodiment. The width of the bypass element 152 is also not particularly limited, and is about 0.5 mm in the present embodiment. The interval between the second antenna portion 151b of the antenna element 151 and the first bypass portion 152a of the bypass element 152 is not particularly limited, and is about 1 mm in the present embodiment. The intervals between parts of the first bypass portion 152a of the bypass element 152 that extend back and forth are not particularly limited, and are about 0.5 mm in the present embodiment.

The structure of the antenna unit 15 is not particularly limited. The antenna unit 15 may be formed of, for example, a Cu wire in a flexible printed circuit or a metal sheet obtained by plating a stainless steel substrate with Ni. In the case where a metal sheet obtained by plating a stainless steel substrate with Ni is used, the metal sheet may be plated with Au in areas corresponding to the feeder contact 215 and the ground contact 216.

### Current Distribution in Bypass Element 152

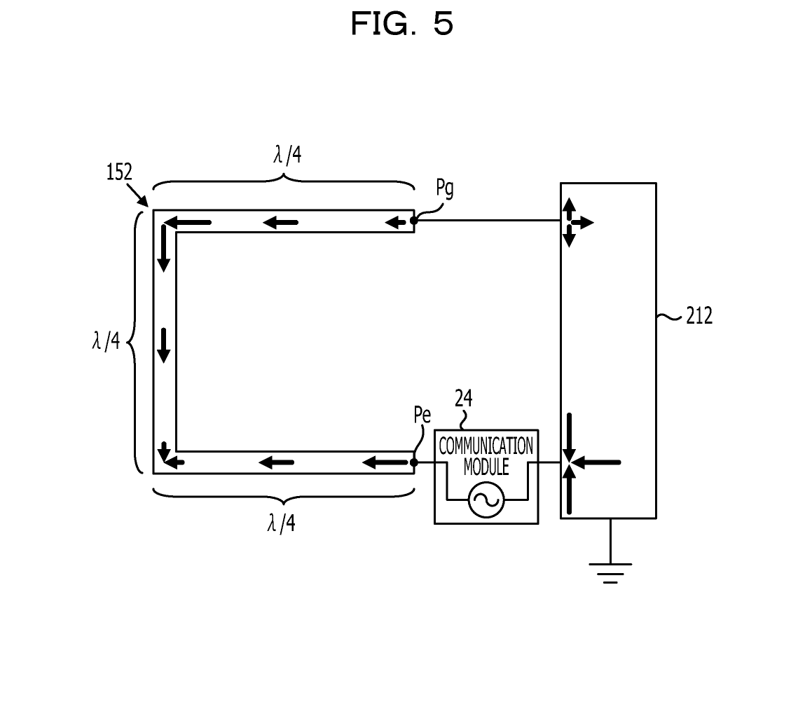

FIG. 5 is a schematic diagram illustrating a current distribution in the bypass element 152 of the antenna unit 15 according to the first embodiment. FIG. 5 schematically illustrates the bypass element 152, and the arrows indicate the direction and magnitude of the high-frequency current generated in the bypass element 152.

When a high-frequency voltage is applied to the feeder point Pe by the communication module 24, the high-frequency current is generated in the bypass element 152. The current generated in the bypass element 152 is hereinafter referred to as a bypass current.

Since the length of the bypass element 152 is set to 3λ/4, the bypass current resonates in the bypass element 152 and forms a standing wave having antinodes and nodes. The antinodes are at positions where the distance from the feeder point Pe is 0 and 2λ/4, and the nodes are at positions where the distance from the feeder point Pe is λ/4 and 3λ/4. In the range in which the distance from the feeder point Pe is 2λ/4 to 3λ/4, the bypass current flows in the direction from the ground point Pg to the feeder point Pe.

Specifically, in the range in which the distance from the feeder point Pe is 2λ/4 to 3λ/4, the magnitude of the bypass current decreases as the distance from the feeder point Pe increases. The magnitude of the bypass current is 0 at the position where the distance from the feeder point Pe reaches 3λ/4, that is, at the ground point Pg.

Accordingly, a high-frequency current that diffuses into the ground pattern 212 from the ground point Pg is generated in an area near the ground point Pg in the ground pattern 212.

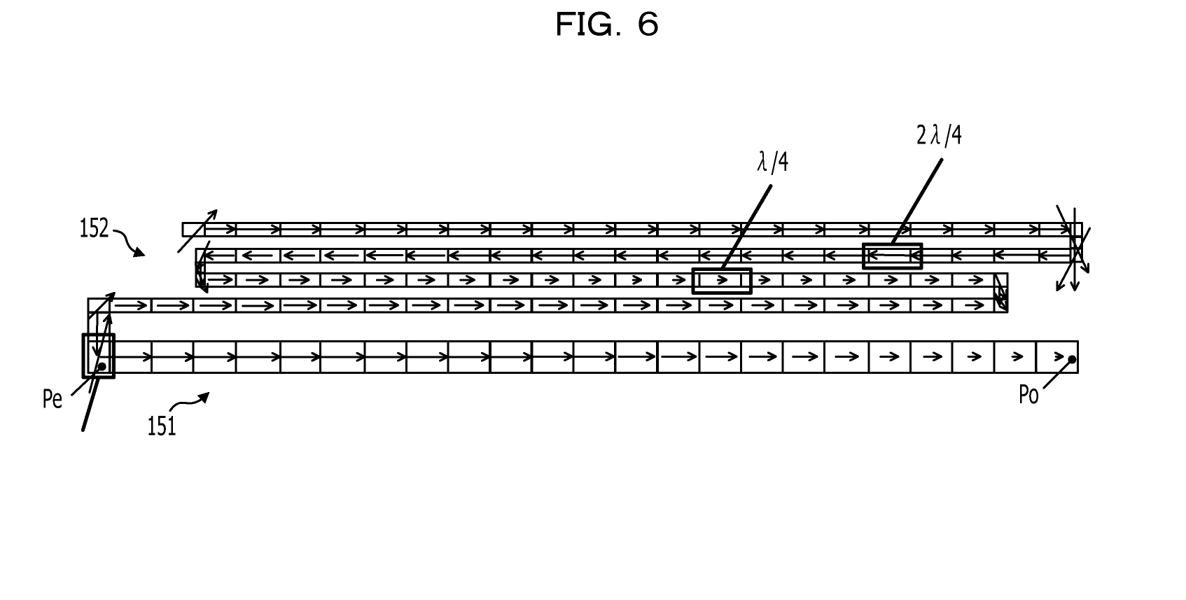

FIG. 6 illustrates the result of simulation of the current distribution in the antenna unit 15 according to the first embodiment. In FIG. 6, the arrows indicate the direction and magnitude of the high-frequency current generated in the antenna unit 15. The symbols “0”, “λ/4”, and “2λ/4” in FIG. 6 indicate that the distance from the feeder point Pe is 0, λ/4, and 2λ/4, respectively.

As is clear from the simulation result illustrated in FIG. 6, a standing wave is generated which has antinodes at positions where the distance from the feeder point Pe is 0 and 2λ/4 and a node at a position where the distance from the feeder point Pe is λ/4. Since the antenna unit 15 is viewed in one direction in FIG. 6, the high-frequency current at the position where the distance from the feeder point Pe is 3λ/4 is not illustrated. However, it is confirmed that a node of the standing wave is generated at the position where the distance from the feeder point Pe is 3λ/4. The above-described simulation result also indicates that the high-frequency current that diffuses into the ground pattern 212 from the ground point Pg is generated in an area near the ground point Pg in the ground pattern 212.

### Current Distribution in Ground Pattern 212

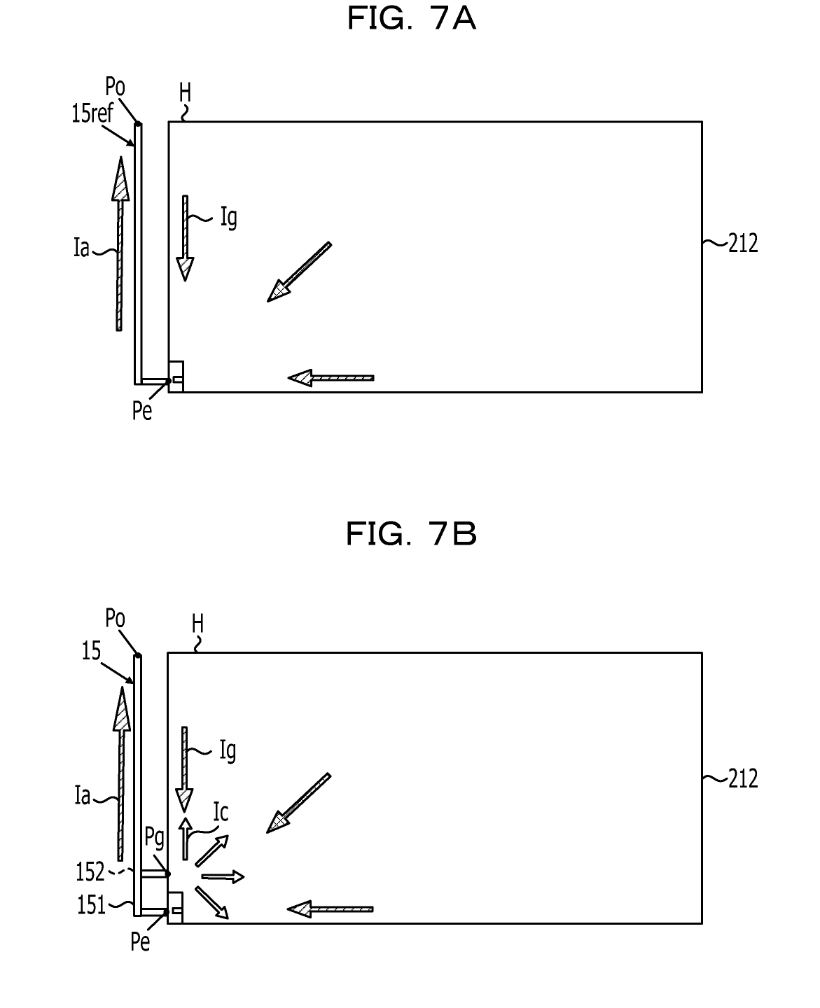

FIGS. 7A and 7B are schematic diagrams which each illustrate a current distribution in the ground pattern 212 on the circuit board 21 according to the first embodiment. FIG. 7A illustrates a current distribution generated when a high-frequency voltage is applied to a comparative antenna unit 15ref that does not include the bypass element 152. FIG. 7B illustrates a current distribution generated when a high-frequency voltage is applied to the antenna unit 15 including the bypass element 152.

Referring to FIG. 7A, when a high-frequency voltage is applied to the comparative antenna unit 15ref that does not include the bypass element 152, a high-frequency current Ig is generated in the ground pattern 212 in an area near the comparative antenna unit 15ref. The high-frequency current Ig flows parallel to the bottom edge H of the circuit board 21 and has a phase opposite to that of an antenna current Ia. The high-frequency current that flows parallel to the bottom edge H of the circuit board 21 in the ground pattern 212 and that has a phase opposite to that of the antenna current Ia is hereinafter referred to as a ground current Ig.

Accordingly, the electric wave generated by the antenna current Ia is partially canceled by the electric wave generated by the ground current Ig. As a result, the input impedance of the comparative antenna unit 15ref decreases. Therefore, it is difficult to achieve good antenna characteristics with the comparative antenna unit 15ref that does not include the bypass element 152.

In contrast, referring to FIG. 7B, when a high-frequency voltage is applied to the antenna unit 15 that includes the bypass element 152, a high-frequency current Ic is generated in the ground pattern 212 in an area near the ground point Pg, as described above in the Current Distribution in Bypass Element 152 section. The high-frequency current Ic flows parallel to the bottom edge H of the circuit board 21 and has the same phase as that of the antenna current Ia. The high-frequency current that flows parallel to the bottom edge H of the circuit board 21 in the ground pattern 212 and that has the same phase as that of the antenna current Ia is hereinafter referred to as a cancelling current Ic.

Accordingly, the ground current Ig that flows through the ground pattern 212 is partially canceled by the cancelling current Ic, and the reduction in the input impedance of the antenna unit 15 is reduced. Therefore, good antenna characteristics can be achieved by the antenna unit 15 including the bypass element 152.

### VSWR of Antenna Unit 15

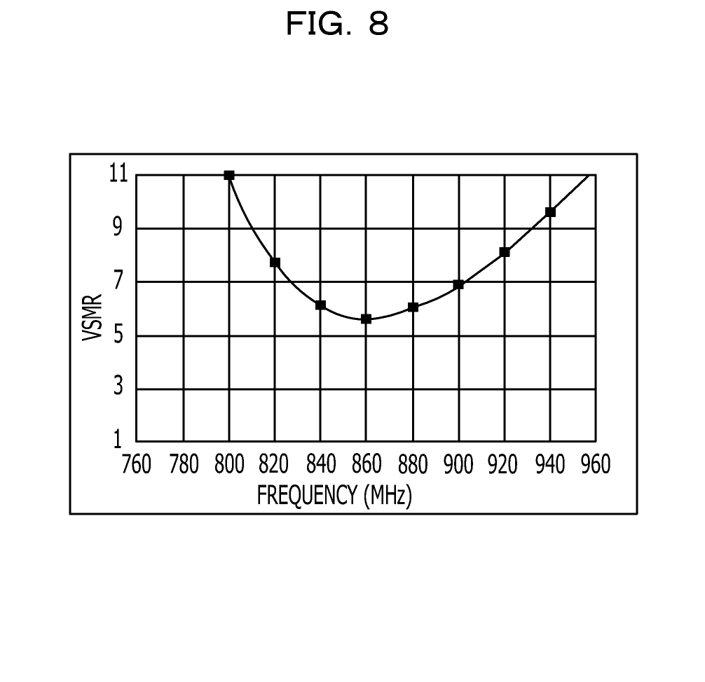

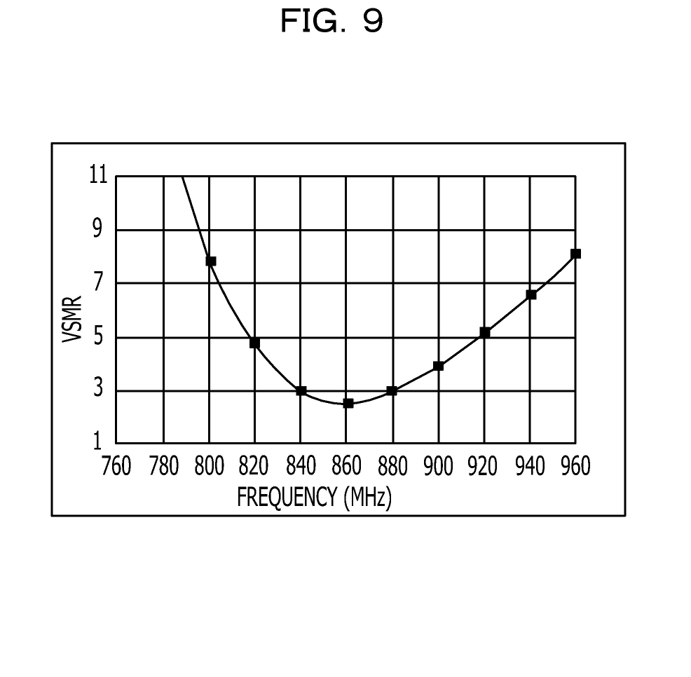

FIG. 8 is a graph of the voltage standing wave ratio (VSWR) of the comparative antenna unit 15ref that does not include the bypass element 152 according to the first embodiment. FIG. 9 is a graph of the VSWR of the antenna unit 15 that includes the bypass element 152 according to the first embodiment.

It is clear from FIGS. 8 and 9 that the VSWR of the antenna unit 15 including the bypass element 152 is lower than the VSWR of the comparative antenna unit 15ref that does not include the bypass element 152.

In particular, in the bandwidth of, for example, 840 MHz to 880 MHz which is used by the mobile phone, the VSWR of the comparative antenna unit 15ref that does not include the bypass element 152 is 5 or more. In contrast, the VSWR of the antenna unit 15 including the bypass element 152 is 3 or less.

As described above, according to the present embodiment, the bypass element 152 connected to the ground pattern 212 is connected to the inverted L-shaped monopole antenna 151, which has a length of λ/4, at a position near the feeder point Pe so that the distance between the feeder point Pe and the ground point Pg is 3λ/4. Accordingly, the ground current Ig, which has a phase opposite to that of the antenna current Ia and flows through an area near the antenna unit 15 in the ground pattern 212, is reduced. As a result, the high-frequency power supplied from the feeder 213 is efficiently transmitted from the antenna element 151 of the antenna unit 15 as electric waves, and deterioration of the antenna characteristics may be suppressed.

In the present embodiment, the bypass element 152 is grounded at a position near the feeder point Pe of the antenna unit 15. Accordingly, the cancelling current Ic having a high current density is generated at the position near the feeder point Pe of the antenna unit 15. As a result, the ground current Ig, which concentrates in an area near the feeder point Pe of the antenna unit 15 and has a phase opposite to that of the antenna current Ia, may be effectively canceled.

According to the present embodiment, the bypass element 152 is made of a material similar to that of the antenna element 151 so as to extend back and forth along the width of the mobile phone. However, the embodiment is not limited to this. Specifically, the bypass element 152 is not used as an antenna that emits electric waves, but is used to generate the cancelling current Ic in the ground pattern 212. Therefore, the material and shape of the bypass element 152 are not limited as long as the cancelling current Ic can be generated. For example, the bypass element 152 may be provided on the circuit board 21.

### Second Embodiment

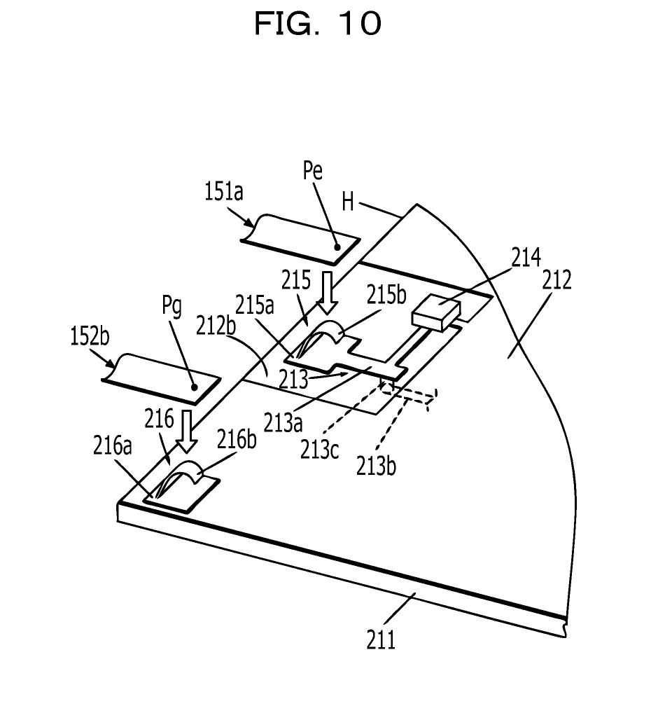

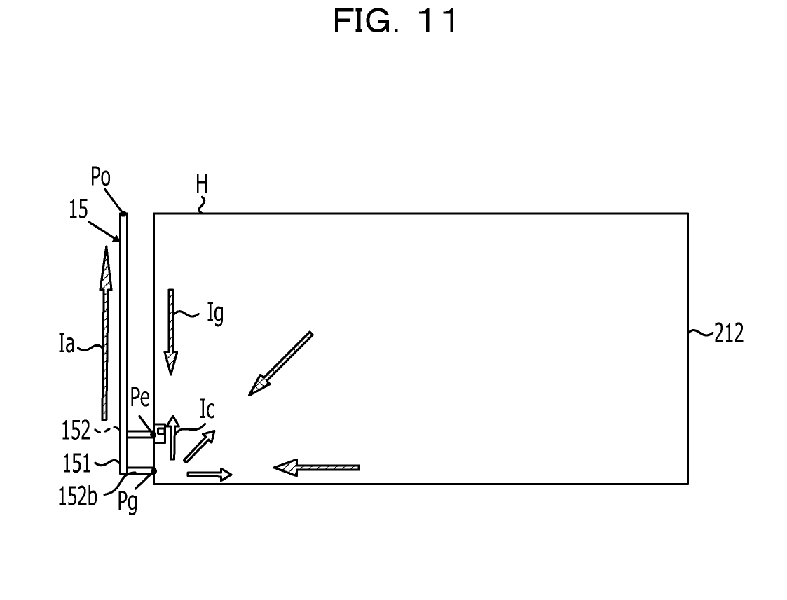

A second embodiment will now be described with reference to FIGS. 10 and 11. Explanations of structures, functions, etc., similar to those in the first embodiment will be omitted.

FIG. 10 is a perspective view of a connecting section between an electronic unit 14 and an antenna unit 15 according to a second embodiment. FIG. 11 is a schematic diagram illustrating a current distribution in a ground pattern on a circuit board 21 according to the second embodiment.

In the first embodiment, the second bypass portion 152b of the bypass element 152 of the antenna unit 15 is connected to the ground pattern 212 at a position closer to the center of the bottom edge H of the circuit board 21 than the feeder point Pe. In the present embodiment, as illustrated in FIG. 10, the second bypass portion 152b is connected to the ground pattern 212 at a position closer to an end of the bottom edge H of the circuit board 21 than the feeder point Pe. Therefore, in the present embodiment, a vacant area 212b is not formed at the lower right corner S of the mobile phone, but is formed in an area shifted toward the center of the bottom edge H of the core substrate 211 from the lower right corner S.

Thus, the second bypass portion 152b of the bypass element 152 is connected to the ground pattern 212 at a position near the end of the bottom edge H of the circuit board 21. In this case, as illustrated in FIG. 11, the cancelling current Ic, which is generated in an area near the ground point Pg in the ground pattern 212 and which is parallel to the bottom edge H of the circuit board 21, contributes to cancelling the ground current Ig over the entire area of the ground pattern 212 in which the ground pattern 212 is opposed to the antenna element 151. As a result, deterioration of the antenna characteristics may be further suppressed.

### Third Embodiment

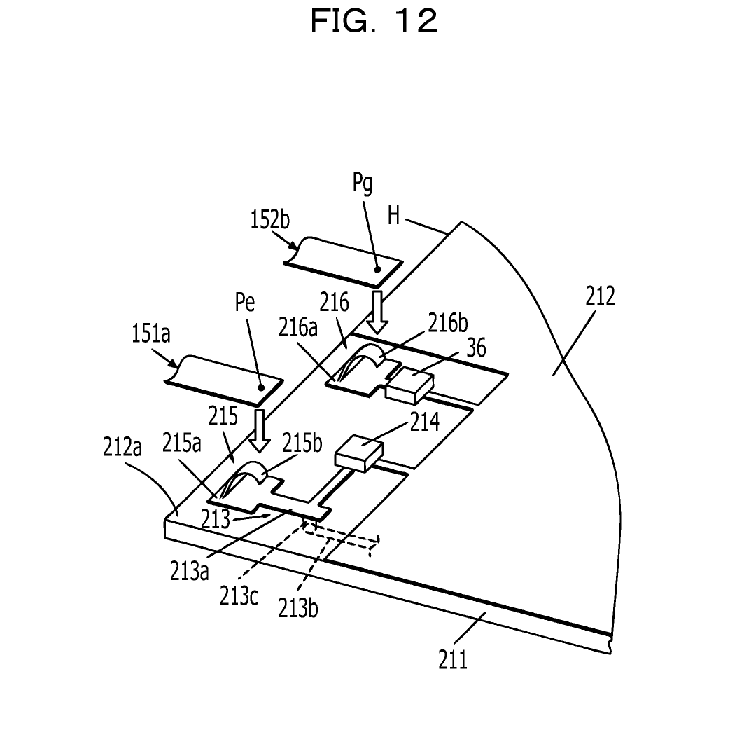

A third embodiment will now be described with reference to FIGS. 12 to 14. Explanations of structures, functions, etc., similar to those in the first or second embodiment will be omitted.

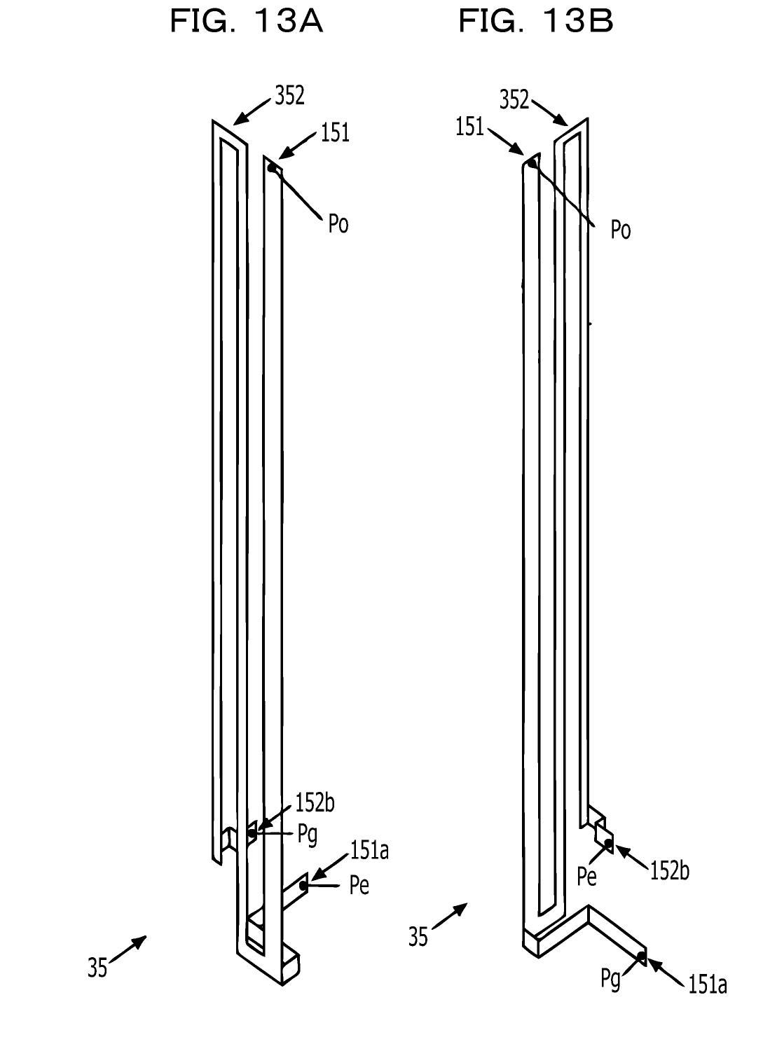

FIG. 12 is a perspective view of a connecting section between an electronic unit 14 and an antenna unit 35 according to a third embodiment. FIGS. 13A and 13B are perspective views of the antenna unit 35 according to the third embodiment.

In the first and second embodiments, the length of the bypass element 152 of the antenna unit 15 is set to 3λ/4. In the third embodiment, a coil 36 is disposed between a bypass element 352 and the ground pattern 212, as illustrated in FIG. 12, and the length of the bypass element 352 of the antenna unit 35 is set to be smaller than 3λ/4, as illustrated in FIG. 13.

The length (wire length) of the coil 36 corresponds to the difference between the length (3λ/4) of the bypass element 152 according to the first and second embodiments and the length of the bypass element 352. Thus, the total length of the bypass element 352 and the coil 36 according to the present embodiment is set to 3λ/4, similar to the bypass element 152 according to the first and second embodiments. The type of the coil 36 is not particularly limited. In the present embodiment, a packaged component is used. Although the coil 36 is mounted on the circuit board 21 in the present embodiment, the embodiment is not limited to this.

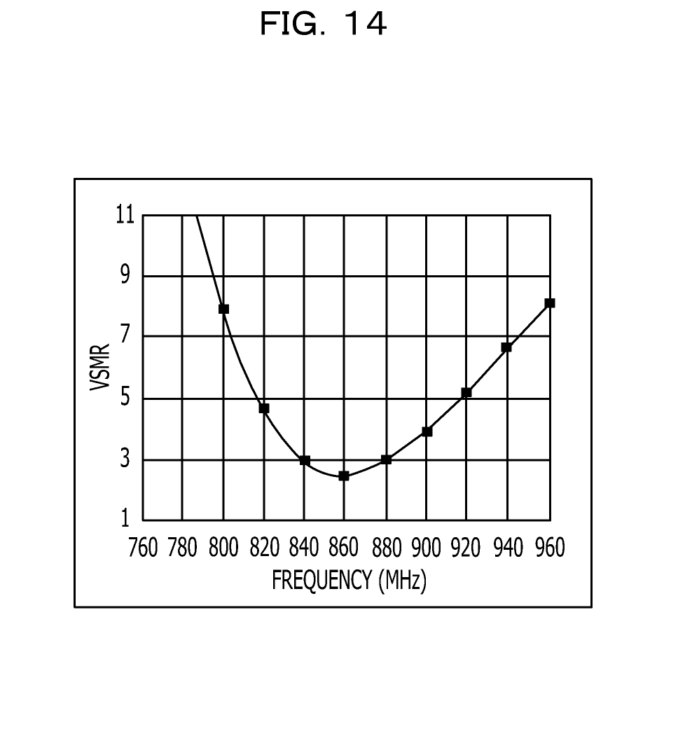

FIG. 14 is a graph of the VSWR of the antenna unit 35 including the bypass element 352 according to the third embodiment.

As is clear from FIG. 14, in the bandwidth of about 840 MHz to 880 MHz which is used by the mobile phone, the VSWR of the antenna unit 35 including the bypass element 352 is 3 or less.

As described above, also when the bypass element 352 and the coil 36 are combined so that the distance between the feeder point Pe and the ground point Pg is 3λ/4, the cancelling current Ic having the same phase as that of the antenna current Ia is generated in an area near the ground point Pg in the ground pattern 212. Accordingly, the ground current Ig is partially canceled by the cancelling current Ic, and deterioration of the antenna characteristics of the antenna unit 35 may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus which performs a communication using high-frequency wave having a wavelength of λ, the apparatus comprising:
a circuit board including a feeder point and a ground;
an antenna element connected to the feeder point; and
a wiring element including a first end portion and a second end portion different from the first end portion, the first end portion being connected to one of the feeder point and the antenna element, the second end portion being connected to the ground,
wherein the antenna element has a length of λ/4, and the wiring element has a length of 3λ/4.

2. The wireless communication apparatus according to claim 1, wherein
the antenna element includes a portion extending parallel to a first edge of the circuit board.

3. The wireless communication apparatus according to claim 2, wherein
the second end portion is connected to the ground at the first edge.

4. The wireless communication apparatus according to claim 2, wherein
the circuit board includes a second edge and a third edge crossing the first edge, and
the feeder point and the second end portion are positioned closer to the second edge than the third edge in the first edge.

5. The wireless communication apparatus according to claim 4,
wherein the second end portion is positioned closer to the second edge than the feeder point.

6. The wireless communication apparatus according to one of claim 1, wherein the wiring element includes:
a plate-shaped member having a plate-shape and connected to one of the feeder point and the antenna element; and
a coil connected between the plate-shaped member and the ground.
